(19) United States
(12) Patent Application Publication
(10) Pub. No.: US 2008/0048948 A1
(43) Pub. Date: Feb. 28, 2008

(54) DISPLAY DEVICE, FLEXIBLE MEMBER, AND METHOD THEREOF

(75) Inventors: Byung-sik KOH, Gwangmyeong-si (KR); Joon-chul GOH, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/778,718

(22) Filed: Jul. 17, 2007

(30) Foreign Application Priority Data
Aug. 22, 2006 (KR) 10-2006-0079379

(51) Int. Cl. G09G 3/30

(52) U.S. Cl. 345/80

(57) ABSTRACT

A display device includes a display panel having a display region where an organic light emitting layer is formed and a non-display region, a circuit board which generates a reference voltage and a panel driving signal to be applied to the display panel, and a flexible member which connects the display panel to the circuit board. The display panel further includes a reference voltage pad which receives the reference voltage and formed on the non-display region, and the flexible member includes a flexible film, a data driving part seated on the flexible film, and a reference voltage lead formed on the flexible film to be connected to the reference voltage pad.

This application claims priority to Korean Patent Application No. 2006-0079379, filed on Aug. 22, 2006 and all the benefits accruing therefrom under 35 U.S.C. §119, and the contents of which in its entirety are herein incorporated by reference.

### BACKGROUND OF THE INVENTION

1. Field of the Invention

The present invention relates to a display device, a flexible member, and a method thereof, and more particularly, to a display device receiving a driving voltage or a common voltage, a flexible member for the display device, and a method of supplying a voltage to a display panel of the display device.

2. Description of the Related Art

Recently, organic light emitting diode (“OLED”) devices have attracted attention and interest in the industry of flat panel display devices because of their low-power requirements, light weight, slim shape, wide viewing angle, high-speed response, and other beneficial attributes. In an OLED device, a plurality of thin film transistors (“TFTs”) is formed on an OLED substrate. An anode electrode, such as a pixel electrode receiving a data voltage, and a cathode electrode, which receives a reference voltage, are formed on the TFTs.

The TFTs include a switching transistor formed at an intersection of a gate line and a data line and a driving transistor connected to a power supply line, wherein the lines form the boundary of a pixel. Pads are disposed on the OLED substrate to supply voltages, such as a common voltage as a reference voltage, which is applied to the cathode electrode, and a driving voltage, which is applied to the power supply line.

As display devices have been increasing in size and including more pixels for higher resolution, a common voltage and a driving voltage, correspondingly, need to be supplied sufficiently to drive the display devices. In order to supply power stably and uniformly throughout a substrate, the common voltage and the driving voltage are supplied from a printed circuit board (“PCB”) and a flexible printed circuit board (“FPCB”) at a lateral side of the substrate, not from a gate driving integrated circuit (“IC”) or a data driving IC.

However, the common voltage and the driving voltage may drop due to resistance of the PCB and FPCB, and the overall size and a manufacturing cost of the substrate increases due to the PCB and the FPCB.

### BRIEF SUMMARY OF THE INVENTION

Accordingly, it is an aspect of the present invention to provide a display device that has a simple configuration to easily supply a driving voltage or a common voltage.

It is a further aspect of the present invention to provide a flexible member for such a display device.

It is a further aspect of the present invention to provide a method of applying a voltage to a display panel of such a display device using the flexible member.

The foregoing and/or other aspects of the present invention are achieved by providing a display device including a display panel including a display region where an organic light emitting layer is formed and a non-display region, a circuit board which generates a reference voltage and a panel driving signal to be applied to the display panel, and a flexible member which connects the display panel to the circuit board, the display panel further including a reference voltage pad which receives the reference voltage formed on the non-display region, and the flexible member including a flexible film, a data driving part seated on the flexible film, and a reference voltage lead formed on the flexible film to be connected to the reference voltage pad.

The reference voltage may include a driving voltage, the display panel may further include a power supply line formed in the display region, and the reference voltage pad may include a power supply pad which applies the driving voltage to the power supply line.

The flexible member may be connected to a first side of the non-display region of the display panel and the power supply pad may be formed in the first side of the non-display region where the flexible member is connected. The display device may further include an additional power supply pad formed in a second side on the non-display region where the flexible member is not connected, and an additional flexible member providing a driving voltage to the additional power supply pad.

The reference voltage may include a common voltage, the display panel may further include a common electrode formed on the organic light emitting layer, and the reference voltage pad may include a common voltage pad which applies the common voltage to the common electrode.

The flexible member may be connected to a first side of the non-display region of the display panel, and the common voltage pad may be formed in the first side of the non-display region where the flexible member is connected. The display device may further include an additional common voltage pad formed in a second side on the non-display region where the flexible member is not connected, and an additional flexible member providing a common voltage to the additional common voltage pad.

The display device may further include a gate line and a data line formed in the display panel and insulatingly crosses each other, and gate leads formed on the flexible film to be connected to the gate line.

The display device may further include data leads formed on the flexible film and which connects the data driving part to the data line. The reference voltage lead may be formed in plural and formed on first and second sides of the flexible film, and the data leads may be disposed between reference voltage leads on the first side of the flexible film and reference voltage leads on the second side of the flexible film.

The display device may further include a gate driving part which receives a gate signal through the gate leads and transmits the gate signal to the gate line, wherein the gate driving part may be mounted on the non-display region. The gate driving part may include a shift register provided at an end portion of the gate line.

The foregoing and/or other aspects of the present invention are achieved by providing a flexible member connected to a circuit board and to a display panel, the display panel including a display region where an organic light emitting layer is formed, a reference voltage pad formed on a non-display region of the display panel, and a gate line and a data line formed in the display region and which insulatingly crosses each other, the flexible member including a flexible film a reference voltage lead formed on the flexible film and connected to the reference voltage pad, a data lead connected to the data line, and a gate lead connected to the gate line.

The reference voltage lead may include at least one of a common voltage lead and a power supply lead.

The flexible member may further include a data driving part seated on the flexible film and connected to the data lead.

The foregoing and/or other aspects of the present invention are achieved by providing a method of applying a voltage to a display panel of a display device, the method including connecting a flexible member between a circuit board and the display panel, the flexible member including a flexible film, a data driving part, and a data lead which connects the data driving part to the circuit board and to the display panel, disposing a voltage pad on the display panel adjacent the flexible member, and including a voltage lead on the flexible film, the voltage lead connects the circuit board to the voltage pad, wherein a voltage from the circuit board is applied to the display panel via the voltage lead and the voltage pad.

The voltage may be a driving voltage, the voltage pad may be a power supply pad, and the method may further include connecting the power supply pad to power supply lines of the display panel to supply the driving voltage to the power supply lines.

The voltage may be a common voltage, the voltage pad may be a common voltage pad, and the method may further include connecting the common voltage pad to a common electrode of the display panel to supply the common voltage to the common electrode.

The voltage lead may be a power supply lead, the voltage may be a driving voltage, the voltage pad may be a power supply pad, and the method may further include connecting the power supply pad to power supply lines of the display panel to supply the driving voltage to the power supply lines, disposing a common voltage pad on the display panel adjacent the flexible member, including a common voltage lead on the flexible film, the common voltage lead connects the circuit board to the common voltage pad, and connecting the common voltage pad to a common electrode of the display panel to supply a common voltage to the common electrode.

The method may further include including a gate lead on the flexible film, and the gate lead connects the circuit board to a gate driving part.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a schematic plan view of an exemplary display device according to a first exemplary embodiment of the present invention;

FIG. 2 is an equivalent diagram of an exemplary pixel in the exemplary display device according to the first exemplary embodiment of the present invention;

FIG. 3 is a schematic plan view of an exemplary display device according to a second exemplary embodiment of the present invention;

FIG. 4 is a front plan view of an exemplary flexible member according to a third exemplary embodiment of the present invention;

FIG. 5 is a schematic plan view of an exemplary display device according to a fourth exemplary embodiment of the present invention;

FIG. 6 is a front plan view of an exemplary flexible member according to a fifth exemplary embodiment of the present invention; and

FIG. 7 is a schematic plan view of an exemplary display device according to a sixth exemplary embodiment of the present invention.

### DETAILED DESCRIPTION OF THE INVENTION

Reference will now be made in detail to exemplary embodiments of the present invention, examples of which are illustrated in the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

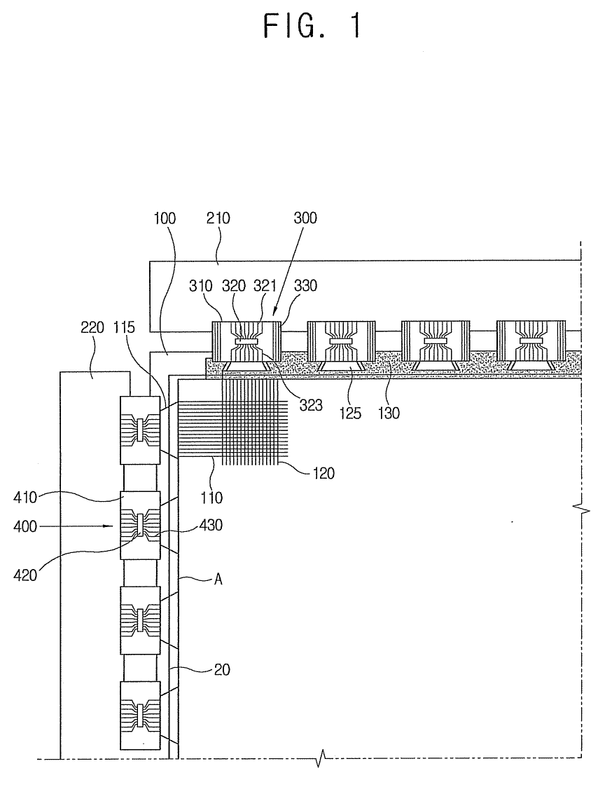

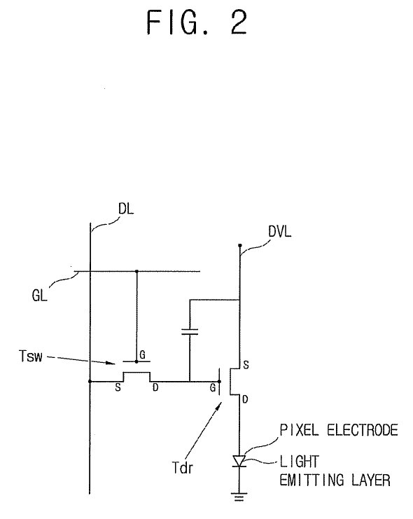

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. Referring to FIGS. 1 and 2, a display device includes a display panel 100, circuit boards 210 and 220, and a plurality of flexible members 300 and 400. The display panel 100 has a display region A and a non-display region surrounding the display region A. The circuit boards 210 and 220 generate driving signals to be applied to the display panel 100, and the flexible members 300 and 400 connect the display panel 100 to the circuit boards 210 and 220, respectively. A power supply pad 130 is formed in the non-display region to supply a driving voltage to the display panel 100.

Gate lines 110, data lines 120 and power supply lines (not shown) extend in the display region A. The gate lines 110 extend perpendicularly to the data lines 120 and the power supply lines to form a plurality of pixels having a rectangular shape. An organic light emitting layer (not shown) is formed on the pixels, and a common electrode 20 is formed on the organic light emitting layer throughout the display region A. The power supply lines are formed parallel with the data lines 120. The power supply lines are positioned in a data metal layer and generally formed in the same layer of the display panel 100 as the data lines 120.

First, an equivalent circuit diagram of a pixel formed under the common electrode 20 will be described as follows. Referring to FIG. 2, one pixel includes a switching transistor Tsw which is electrically connected to a gate line GL and a data line DL, a driving transistor Tdr which is electrically connected to a drain electrode D of the switching transistor Tsw and a power supply line or driving voltage line DVL, and a pixel electrode which is physically and electrically connected to the driving transistor Tdr. The pixel further includes a light emitting layer which may emit light by applying a voltage from the pixel electrode.

The gate lines GL are disposed substantially parallel to each other and cross over the data lines DL and the power supply lines DVL to define pixels. A gate metal layer includes the gate lines GL and gate electrodes G of the transistors Tsw and Tdr and may be a single layer of gate material or multiple layers of gate material. The gate lines GL apply a gate on/off voltage to the switching transistors Tsw which are connected to each of the gate lines GL.

A data metal layer includes the data lines DL, which cross over the gate lines GL, and drain electrodes D and source electrodes S of the transistors Tsw and Tdr. The data metal layer is insulated from the gate metal layer. The data lines DL apply a data voltage to the switching transistors Tsw.

The power supply lines DVL are disposed substantially parallel with the data lines DL and intersect the gate lines GL to form the pixels in substantially a matrix shape. The power supply lines DVL are generally disposed in the same layer as the data lines DL, e.g., they may be formed in the data metal layer. According to one exemplary embodiment, one power supply line DVL may be disposed in every pixel. However, alternative exemplary embodiments include configurations wherein a power supply line DVL is disposed between two pixels. Two adjacent pixels sharing one power supply line DVL may be applied with a driving voltage through the one power supply line DVL. In the exemplary embodiment of the present invention wherein a power supply line DVL is shared between at least two pixels, the display device includes fewer lines, a manufacturing process thereof is simplified and electromagnetic interference decreases.

The switching transistor Tsw includes the gate electrode G, which is connected to a portion of the gate line GL, the source electrode S which is branched from the data line DL, the drain electrode D which is separated from the source electrode S, and a semiconductor layer formed between the source and drain electrodes S, D and the gate electrode G. The gate on voltage, which is applied to the gate line GL, is delivered to the gate electrode G of the switching transistor Tsw. Accordingly, the data voltage applied from the data line DL is transmitted to the drain electrode D through the source electrode S.

The driving transistor Tdr controls an electric current between the drain electrode D and the source electrode S of the driving transistor Tdr according to the data voltage provided to the gate electrode G thereof. A voltage applied to the pixel electrode through the drain electrode D corresponds to a difference between the data voltage provided to the gate electrode G and the driving voltage provided to the source electrode S.

The pixel electrode functions as an anode and provides holes to the organic light emitting layer.

The common electrode 20 is provided throughout the display region A. Accordingly, an electric current in the common electrode 20 passes to the organic light emitting layer in each pixel.

Returning to FIG. 1, the plurality of flexible members 300 and 400 adhere in the non-display region outside the display region A. The circuit boards 210 and 220 are connected to one side of each of the flexible members 300 and 400. An anisotropic conductive film (not shown) may be used for connecting the flexible members 300 and 400 to the display panel 100 and the circuit boards 210 and 220. The flexible members 300 and 400 include a first flexible member 300 to connect a data circuit board 210 and the display panel 100, and a second flexible member 400 to connect a gate circuit board 220 and the display panel 100. The data lines 120 and the gate lines 110 extend outside the display region A to be connected with the first flexible members 300 and the second flexible members 400, respectively.

A gate fan out part 115 and a data fan out part 125 are formed in an area where the gate lines 110 and the data lines 120 connect to the first flexible members 300 and the second flexible members 400, respectively. The gate fan out part 115 and the data fan out part 125 are formed in an area where the wiring intervals become narrow. The power supply pad 130 is formed outside the display region A where the first flexible member 300 adheres. The power supply pad 130 is connected to the power supply lines, such as power supply line DVL in FIG. 2, which are formed in the display region A to deliver a driving voltage from the first flexible members 300 to the power supply lines. Generally, the power supply lines are formed in the same metal layer as the data lines 120, but the power supply pad 130, which is formed in the non-display region and electrically connected to the power supply lines, is formed in a different metal layer from a layer where the data metal layer is formed so as to be insulated from the data fan out part 125. The power supply pad 130 may be formed in the same layer as the gate metal layer, where the gate line 110 is formed, and may be made of, by example only, indium tin oxide (“ITO”) or indium zinc oxide (“IZO”).

A plurality of the first flexible members 300 is disposed in an extending direction of the gate line 110 outside the display region A. Each first flexible member 300 may correspond to a subset of the data lines 120. The first flexible members 300 each include a flexible film 310, a data driving part 320 seated on the flexible film 310, and power supply leads 330 and data leads 321 and 323, which are formed on the flexible film 310.

The flexible film 310 may be made of, for example, a flexible plastic material.

The data driving part 320 is seated on the flexible film 310 and connected to first data leads 321 and second data leads 323. Each first data lead 321 is connected to the data circuit board 210, and each second data lead 323 is connected to a data pad (not shown) of a data line 120. The data pad of a data line 120 is an extended part from an end portion of the data line 120 forming the data fan out part 125. The data pad is connected to the second data lead 323 to receive a data signal.

The power supply leads 330 are formed on opposite edges of the flexible film 310, and the data leads 321 and 323 are disposed between the power supply leads 330. Alternatively, the power supply leads 330 may be disposed on only one edge of each flexible film 310. A driving voltage generated in the data circuit board 210 is delivered to the power supply pad 130 through the power supply leads 330 formed on the flexible film 310, and then delivered finally to the power supply lines electrically connected to the power supply pad 130.

Conventionally, a driving voltage is not delivered through a flexible member where a data signal is transmitted but through a separate member. In order to provide a driving voltage, a separate flexible film adhered to a flexible member is necessary, through which a plurality of flexible members are connected to a display panel. In addition, an additional flexible member may be necessary for the display panel to apply a common voltage, which complicates a structure of the display panel. However, in the present embodiment, the power supply leads 330 are formed on the flexible film 310 where the data driving part 320 is seated, thereby decreasing the number of the flexible members as compared with a conventional display device. Accordingly, the display panel 100 may have a simpler structure and be manufactured at a lower cost and through a simpler process than the related art.

The second flexible member 400 includes a flexible film 410, a gate driving part 420 seated on the flexible film 410, and gate leads 430 connected to the gate driving part 420. The gate leads 430 are formed between the gate lines 110 and the gate driving part 420, and between the gate driving part 420 and the gate circuit board 220 to electrically connect the gate driving part 420 between the gate lines 110 and the gate circuit board 220. The gate leads 430, which are connected to the gate lines 110, contact a gate pad extended from an end portion of each gate line 110. Further, the gate leads 430 transmit a gate on/off signal and a gate control signal, which are generated in the gate circuit board 220, to the gate driving part 420 and the gate lines 110.

The circuit boards 210 and 220 include the gate circuit board 220, which generates the gate signal, and the data circuit board 210, which generates a data signal and a driving voltage but not the gate signal. It should be noted that the circuit boards 210 and 220 are named only for convenience of description and that their names do not limit the kinds of signals that they generate.

The data circuit board 210 is connected to the display panel 100 through the first flexible members 300. The data circuit board 210 includes a voltage generating part which generates various voltages such as a data signal to be provided to a display region A, and a timing controller which outputs various control signals to be provided to the gate driving part 420 and the data driving part 320. Alternatively, the data circuit board 210 may include a plurality of circuit boards divided into parts to generate a gray scale voltage and to receive an image signal respectively. Namely, a plurality of the data circuit boards 210 may be connected to the data driving parts 320.

The gate circuit board 220 is connected to the display panel 100 through the second flexible members 400 and applies a gate signal, which includes a gate on voltage and a gate off voltage to turn on and off the TFTs respectively, and a control signal to control the gate signal, to the gate driving part 420.

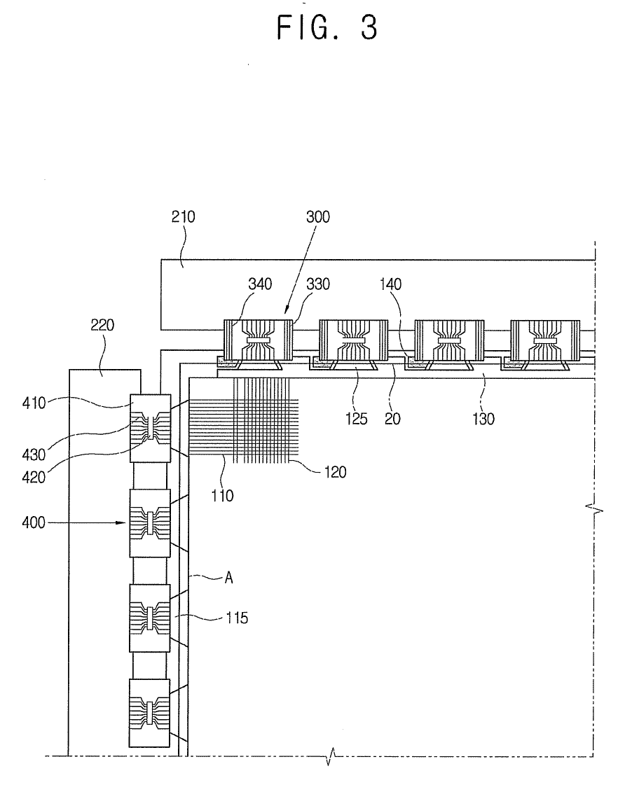

FIG. 3 is a schematic plan view of an exemplary display device according to a second exemplary embodiment of the present invention. In the second exemplary embodiment, the display device further includes a common voltage pad 140 outside the display region A. Also, a first flexible member 300 further includes common voltage leads 340, which are electrically connected to the common voltage pad 140. In the illustrated embodiment, common voltage leads 340 are provided on each first flexible member 300.

Referring to FIG. 3, the common voltage pad 140 is disposed adjacent to each first flexible member 300 and between adjacent first flexible members 300 and does not overlap with a power supply pad 130. In the present embodiment, the common voltage pad 140 is formed in a gate metal layer where a gate line 110 and the power supply pad 130 are formed and does not overlap with the power supply pad 130 so as to be electrically isolated from the power supply pad 130. The common voltage pad 140 may be overlapped by data fan out part 125, due to the data fan out part 125 being formed in a different layer. While a particular embodiment of the common voltage pad 140 has been illustrated and described, the common voltage pad 140 may have various shapes and locations and may be formed in a different layer from the power supply pad 130. When the common voltage pad 140 is formed in a different layer from the power supply pad 130, the common voltage pad 140 may be formed to overlap with the power supply pad 130, and thus it is relatively easy to pattern the common voltage pad 140. The common voltage pad 140 may in turn be connected to the common electrode 20.

The common voltage leads 340, which are formed on a flexible film 310, supply a common voltage from a circuit board 210 to the common voltage pad 140. The common voltage leads 340 may be formed on a first edge of the flexible film 310, and the power supply leads 330 may be formed on a second edge of the flexible film 310, where the first edge is opposite the second edge. In such a configuration, the data leads 321 and 323 are disposed between the common voltage leads 340 and the power supply leads 330. Since the common voltage leads 340 are formed on the first flexible member 300 where a data driving part 320 is also seated, the common voltage may be supplied to a common electrode 20 without an additional flexible member. It is not necessary to provide an additional flexible member to supply a common voltage or a driving voltage at one side of a display panel 100 where the data driving part 320 is connected, and thus a display panel 100 may have a simple structure and be manufactured at a lower cost.

The common electrode 20 extends to the common voltage pad 140 to be connected with the common voltage pad 140. The common electrode 20 and the common voltage pad 140 are connected with each other by a known method using, for example, a contact hole, an anisotropic conductive film, etc.

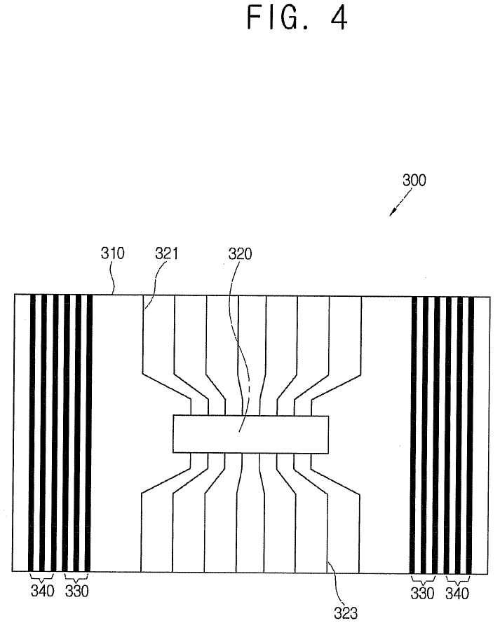

FIG. 4 is a front plan view of an exemplary flexible member according to a third exemplary embodiment of the present invention. A first flexible member 300 includes power supply leads 330 and common voltage leads 340 formed on a flexible film 310. The power supply leads 330 and the common voltage leads 340 formed on the flexible film 310 are disposed differently from the second exemplary embodiment. The power supply leads 330 are provided on first and second opposing edges of the flexible film 310, and the common voltage leads 340 are also provided on the first and second opposing edges of the flexible film 310, with data leads 321 and 323 disposed between the first and second edges and flanked by the power supply leads 330 and the common voltage leads 340. In the illustrated embodiment, the common voltage leads 340 are formed on an outer area of the flexible film 310, and the power supply leads 330 are formed on an inside of the common voltage leads 340, closer to the data driving part 320, however their locations may be reversed. The leads 340 and 330 are thus modified in their configuration to supply the common voltage and the driving voltage, respectively, from a plurality of spots, thereby reducing resistance due to transmission of the common voltage and the driving voltage and promptly delivering the common voltage and the driving voltage to an LCD panel 100.

If positions of the common voltage leads 340 and the power supply leads 330 change, shapes of a common voltage pad 140 and a power supply pad 130 are modified accordingly. While the leads 330 and 340 are illustrated as lines in FIG. 4, the common voltage leads 340 and the power supply leads 330 may alternatively be formed to have an area with a predetermined width, such as each having a single strip shape adjacent one or both edges of the flexible film 300 instead of a series of lines adjacent each edge. Also, widths of the power supply leads 330 and the common voltage leads 340 may be modified properly for a voltage to be applied.

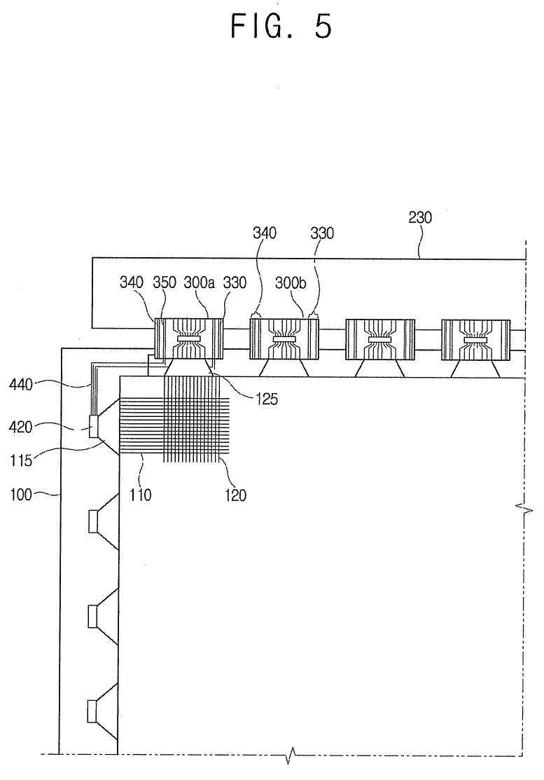

FIG. 5 is a schematic plan view of an exemplary display device according to a fourth exemplary embodiment of the present invention.

Unlike the foregoing exemplary embodiments, the display device according to the present exemplary embodiment does not include a gate circuit board 220 and a second flexible member 400. Instead, a gate driving part 420 is seated on display panel 100. A gate on/off voltage and a gate control signal to be applied to the gate driving part 420 are generated in a data circuit board 230.

A first flexible member 300a includes gate leads 350 in addition to data leads 321 and 323, power supply leads 330, and common voltage leads 340. In the illustrated embodiment, the gate leads 350 are formed symmetrically on the first flexible member 300a with the data leads 321 and 323 disposed there between, and the power supply leads 330 and the common voltage leads 340 are formed outside the gate leads 350. The gate leads 350 are formed only on the first disposed first flexible member 300a closest to the gate driving part 420, because it is efficient to deliver gate signals through the most adjacently disposed first flexible member 300a to the gate driving part 420.

A gate signal pattern 440 is formed on the display panel 100 to transmit the gate signals applied through the gate leads 350 to the gate driving part 420.

Alternatively, the gate leads 350 may be formed on a second or next closely disposed first flexible member 300b. In this case, the gate signal pattern 440 may vary slightly from a gate signal pattern 440 extending from the first flexible member 300a.

The gate signals generated in the data circuit board 230 are delivered to the gate driving part 420 through the gate leads 350 of the first flexible member 300a and the gate signal pattern 440. In this embodiment, the gate driving part 420 is seated on the display panel 100, which is a chip on glass (“COG”) type of assembly. In a COG type display device, a gate circuit board and a flexible member connected to the gate circuit board are omitted and the gate signals are provided instead through the first flexible member 300a, which includes the data driving part 320 seated thereon.

In another exemplary embodiment, a gate driving part 420 is not provided as a chip but may include a shift register, which is connected with an end portion of the gate lines 110. The shift register includes a plurality of transistors formed on the display panel 100 and is formed directly on a display panel 100 while forming the signal wires. If the gate driving part 420 is provided as a shift register, a separate circuit board is not necessary since the gate on/off voltage and the control signals are transmitted directly to the shift register through electric wire.

While particular arrangements have been described, the gate leads 350, the power supply leads 330, and the common voltage leads 340 may be disposed variously, and alternate arrangements are within the scope of these embodiments. The power supply leads 330, the common voltage leads 340, and the gate leads 350 may be formed symmetrically about the gate leads 321 and 323, or some of them may be selectively formed as necessary.

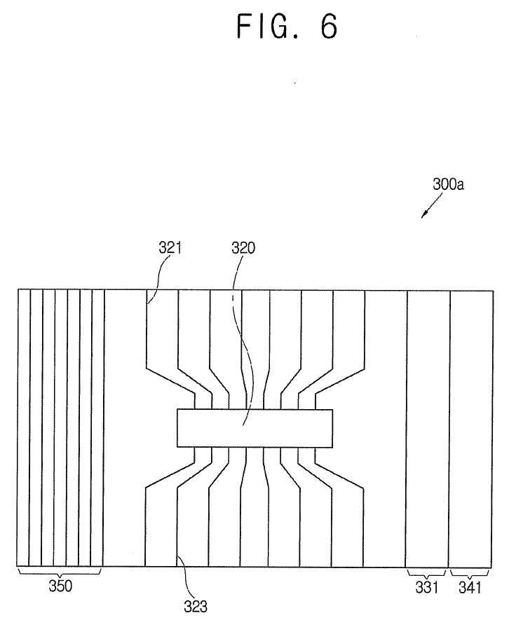

FIG. 6 is a front plan view of an exemplary flexible member according to a fifth exemplary embodiment of the present invention.

FIG. 6 shows a first flexible member 300a, which is disposed first adjacently to a gate driving part 420. Gate leads 350, to deliver a gate signal, that are disposed in an inner area of a display region A, i.e., gate leads 350 that are formed far from a gate driving part 420, render the formation of a gate signal pattern 440 insulated from pads 130 and 140 difficult.

Thus, the gate leads 350 are formed only in an area adjacent to the gate driving part 420 with respect to data leads 321 and 323. The gate leads 350 are formed only along a first edge of the flexible member 300a, and a power supply lead 331 and a common voltage lead 341 are formed along a second edge, opposite the first edge, of the flexible member 300a, with respect to the data leads 321 and 323. Accordingly, the gate signal pattern 440 may be formed more easily and may be relatively short, thereby delivering a gate signal promptly.

In the embodiment shown in FIG. 6, the power supply lead 331 and the common voltage lead 341 are formed in a bar shape with a predetermined area, and thus a driving voltage and a common voltage may be supplied more promptly.

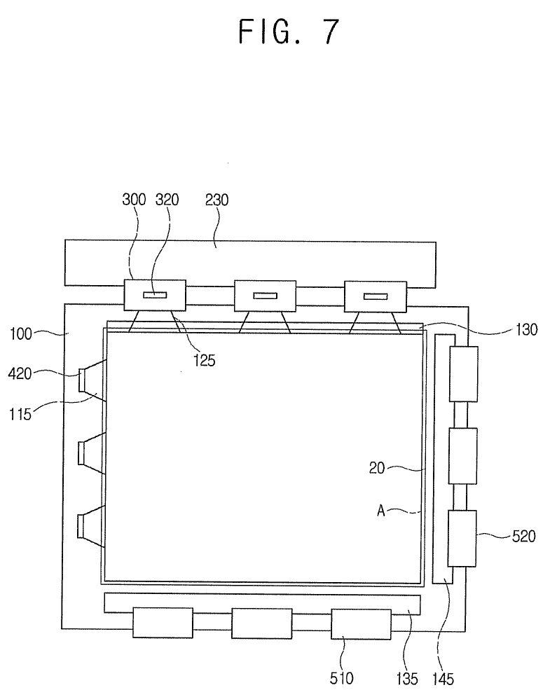

FIG. 7 is a schematic plan view of an exemplary display device according to a sixth exemplary embodiment of the present invention.

The display device according to the sixth exemplary embodiment further includes an additional power supply pad 135 and an additional common voltage pad 145 which are formed outside a display region A where a gate driving part 420 and a data driving part 320 are not connected. The power supply pads 130 and 135 may be disposed on first and second opposing sides of the display panel 100, the gate driving part 420 may be formed on a third side of the display panel 100, and the common voltage pad 145 may be formed on a fourth side of the display panel 100, where the fourth side opposes the third side. The display region A is formed between the first and second sides of the display panel 100, and between the third and fourth sides of the display panel 100. A third flexible member 510 and a fourth flexible member 520 are connected to the additional power supply pad 135 and the additional common voltage pad 145, respectively. Voltage generating parts (not shown) which generate a driving voltage and a common voltage are connected to the third flexible member 510 and the fourth flexible member 520 respectively. The driving voltage and the common voltage which are generated in the voltage generating parts are delivered to the additional power supply pad 135 and the additional common voltage pad 145 through the flexible members 510 and 520 respectively.

If the driving voltage and the common voltage, which are applied to a power supply line and a common electrode, increase as a size of a display panel 100 increases, it may not be enough to supply a voltage only through a first flexible member 300. Thus, it may be necessary to supply the driving voltage and the common voltage through other channels to compensate the insufficiency.

The additional power supply pad 135 is disposed opposite to the first flexible member 300 with the display region A disposed there between, and the additional power supply pad 135 extends along one side of the display region A. The additional power supply pad 135 delivers a predetermined level of driving voltage from the third flexible member 510 to the power supply lines.

The additional common voltage pad 145 is disposed opposite to the gate driving part 420 with the display region A disposed there between, and the additional common voltage pad 145 delivers a predetermined level of common voltage from the fourth flexible member 520 to the common electrode 20. While the common electrode 20 and the additional common voltage pad 145 appear to be separated from each other in FIG. 7, the common electrode 20 and the additional common voltage pad 145 may actually be connected directly with each other or through a bridge electrode, such as a bridge electrode including ITO.

The display device according to the exemplary embodiments includes not only data leads 321 and 323 to transmit a data signal, but also leads to deliver a driving voltage, a common voltage, and a gate signal in the first flexible member 300 where the data driving part 320 is seated, thereby easily providing signals without an additional film or circuit board to the display panel 100.

As described above, the present invention provides a display device having a simple configuration to easily supply a driving voltage or a common voltage.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display device comprising:
a display panel comprising a display region where an organic light emitting layer is formed, and a non-display region;
a circuit board which generates a reference voltage and a panel driving signal to be applied to the display panel; and
a flexible member which connects the display panel to the circuit board,
the display panel further comprising a reference voltage pad which receives the reference voltage and formed on the non-display region, and
the flexible member comprising a flexible film, a data driving part seated on the flexible film, and a reference voltage lead formed on the flexible film to be connected to the reference voltage pad.

2. The display device according to claim 1, wherein the reference voltage comprises a driving voltage, the display panel further comprises a power supply line formed in the display region, and the reference voltage pad comprises a power supply pad which applies the driving voltage to the power supply line.

3. The display device according to claim 2, wherein the flexible member is connected to a first side of the non-display region of the display panel and the power supply pad is formed in the first side of the non-display region where the flexible member is connected.

4. The display device according to claim 3, further comprising an additional power supply pad formed in a second side on the non-display region where the flexible member is not connected, and an additional flexible member which provides a driving voltage to the additional power supply pad.

5. The display device according to claim 1, wherein the reference voltage comprises a common voltage, the display panel further comprises a common electrode formed on the organic light emitting layer, and the reference voltage pad comprises a common voltage pad which applies the common voltage to the common electrode.

6. The display device according to claim 5, wherein the flexible member is connected to a first side of the non-display region of the display panel, and the common voltage pad is formed in the first side of the non-display region where the flexible member is connected.

7. The display device according to claim 6, further comprising an additional common voltage pad formed in a second side on the non-display region where the flexible member is not connected, and an additional flexible member which provides a common voltage to the additional common voltage pad.

8. The display device according to claim 1, further comprising a gate line and a data line formed in the display panel and which insulatingly crosses each other, and gate leads formed on the flexible film to be connected to the gate line.

9. The display device according to claim 8, further comprising data leads formed on the flexible film and which connects the data driving part to the data line.

10. The display device according to claim 9, wherein the reference voltage lead is formed in plural and formed on first and second sides of the flexible film, and the data leads are disposed between reference voltage leads on the first side of the flexible film and reference voltage leads on the second side of the flexible film.

11. The display device according to claim 8, further comprising a gate driving part which receives a gate signal through the gate leads and transmits the gate signal to the gate line, wherein the gate driving part is mounted on the non-display region.

12. The display device according to claim 11, wherein the gate driving part comprises a shift register provided at an end portion of the gate line.

13. A flexible member connected to a circuit board and to a display panel, the display panel comprising a display region where an organic light emitting layer is formed, a reference voltage pad formed on a non-display region of the display panel, and a gate line and a data line formed in the display region and which insulatingly crosses each other, the flexible member comprising:
a flexible film;
a reference voltage lead formed on the flexible film and connected to the reference voltage pad;
a data lead connected to the data line; and
a gate lead connected to the gate line.

14. The flexible member according to claim 13, wherein the reference voltage lead comprises at least one of a common voltage lead and a power supply lead.

15. The flexible member according to claim 13, further comprising a data driving part seated on the flexible film and connected to the data lead.

16. A method of applying a voltage to a display panel of a display device, the method comprising:
connecting a flexible member between a circuit board and the display panel, the flexible member including a flexible film, a data driving part, and a data lead which connects the data driving part to the circuit board and to the display panel;
disposing a voltage pad on the display panel adjacent the flexible member; and,
including a voltage lead on the flexible film, and the voltage lead connects the circuit board to the voltage pad;
wherein a voltage from the circuit board is applied to the display panel via the voltage lead and the voltage pad.

17. The method according to claim 16, wherein the voltage is a driving voltage, the voltage pad is a power supply pad, and the method further comprises connecting the power supply pad to power supply lines of the display panel to supply the driving voltage to the power supply lines.

18. The method according to claim 16, wherein the voltage is a common voltage, the voltage pad is a common voltage pad, and the method further comprises connecting the common voltage pad to a common electrode of the display panel to supply the common voltage to the common electrode.

19. The method according to claim 16, wherein the voltage lead is a power supply lead, the voltage is a driving voltage, the voltage pad is a power supply pad, and the method further comprises:
connecting the power supply pad to power supply lines of the display panel to supply the driving voltage to the power supply lines;
disposing a common voltage pad on the display panel adjacent the flexible member;
including a common voltage lead on the flexible film, the common voltage lead connects the circuit board to the common voltage pad; and,
connecting the common voltage pad to a common electrode of the display panel to supply a common voltage to the common electrode.

20. The method according to claim 19, further comprising including a gate lead on the flexible film, the gate lead connects the circuit board to a gate driving part.
